(19) United States
(12) Patent Application Publication
(10) Pub. No.: US 2022/0209585 A1
(43) Pub. Date: Jun. 30, 2022

(54) WIRELESS CHARGING CASE WITH A SHIELDED BATTERY

(71) Applicant: GN Audio A/S, Ballerup (DK)

(72) Inventors: William Chen, Ballerup (DK); Gavin LI, Ballerup (DK); Winston Chen, Ballerup (DK); Kris Chen, Ballerup (DK)

(21) Appl. No.: 17/169,820

(22) Filed: Feb. 8, 2021

(30) Foreign Application Priority Data
Dec. 30, 2020 (CN) 202011622034.6

(51) Int. Cl. H02J 50/70; H01F 27/36; H02J 50/10; H04R 25/00

(52) U.S. Cl. CPC H02J 50/70; H01F 27/366; H02J 50/10; H04R 2420/07; H02J 2310/22; H04R 2225/31; H04R 2225/49; H04R 25/602

(57) ABSTRACT

A wireless charging case for a headset, which case comprises a housing, a charging receiver coil and a rechargeable battery. The rechargeable battery comprises a first battery side extending between a first edge and a second opposite edge and facing the charging receiver coil, a second battery side lying extending from the first edge and a third battery side extending from the second edge. A magnetic shield sheet is arranged between the charging receiver coil and the first battery side. Parts of the second battery side and third battery side are covered by magnetic shield sheet.

### TECHNICAL FIELD

The invention relates a wireless charging for a headset, which case comprises a housing, a charging receiver coil, a rechargeable battery comprising a first battery side extending between a first edge and a second opposite edge and facing the charging receiver coil, a second battery side lying extending from the first edge and a third battery side extending from the second edge, wherein magnetic shield sheet is arranged between the charging receiver coil and the first battery side.

### BACKGROUND ART

So-called true wireless headsets have been very popular the recent years. True wireless headsets refer to a set of wireless earbuds with no wires or cords, which can be wirelessly connected f. ex. by Bluetooth to a smartphone, a computer etc. Normally these true wireless earbuds are sold with a corresponding charging case, in which they can be kept when not in use and recharged via a built-in rechargeable battery of the charging case. Typically, the battery of the charging case has capacity enough for recharging the earbuds 3-4 times. An example of such a true wireless earbud system is Jabra Elite 75t. Charging of the charging case can be done by connecting the case by means of a cable to a power source. Another way of charging the charging case can be done by inductive charging. Inductive charging (also known as wireless charging or cordless charging) is a type of wireless power transfer. It uses electromagnetic induction to provide electricity to portable devices. The most common application is the Qi wireless charging standard for smartphones, smartwatches and tablets. Inductive charging may cause undesired heating due to the occurrence of eddy currents.

### DISCLOSURE OF INVENTION

According to the invention, the wireless charging case is characterised in that parts of the second battery side and third battery side are covered by magnetic shield sheet material. It has shown, that providing magnetic shielding on sides of the battery not facing the charging coil, reduces heating of the battery during the charging process, whereby the charging can be carried out faster with higher currents.

According to an embodiment, a unitary magnetic shield sheet is wrapped around the first, second and third battery sides.

According to an embodiment, the battery is essentially box shaped, wherein the second and third battery sides are essential parallel and essential orthogonal to the first battery side.

According to an embodiment, the second and third battery sides are essentially fully covered by magnetic shield material.

According to an embodiment, the area of first battery side is between 5 cm² and 10 cm², and the area of the second and third battery sides is between 2.5 cm² and 5 cm².

According to an embodiment, the magnetic shield sheet comprises ferrite.

According to an embodiment, the magnetic shield sheet comprises an amorphous cobalt alloy.

According to an embodiment, the charging receiver coil is arranged at a bottom face of the housing.

According to an embodiment, the magnetic shield sheet is flexible.

According to an embodiment, the magnetic shield sheet adhered to the surface of the.

### BRIEF DESCRIPTION OF THE DRAWINGS

The invention is explained in detail below with reference to the drawing illustrating preferred embodiments of the invention and in which

FIG. 1 is a perspective view of a charging case according to a first embodiment of the invention,

FIG. 2 is a perspective view of the charging case in open state,

FIG. 3 is bottom views of earbuds to be held and charged by the charging case,

FIG. 4 is a cross-sectional view through the charging case,

FIG. 5 is a longitudinal section through the charging case,

FIG. 6 is a simplified perspective view of a battery and a magnetic shield sheet according to prior art,

FIG. 7 is a simplified perspective view of a battery and a magnetic shield sheet according to invention,

FIG. 8 is an exploded view of the major components of the charging case according to a second embodiment of the invention,

FIG. 9 is a schematic longitudinal view of parts of the invention with arrows indicating magnetic field lines during charging,

FIG. 10 is a schematic cross-sectional view through a simplified third embodiment of the invention,

FIG. 11 is a schematic cross-sectional view through a simplified fourth embodiment of the invention, and

FIG. 12 is a schematic cross-sectional view through a simplified fifth embodiment of the invention.

### MODES FOR CARRYING OUT THE INVENTION

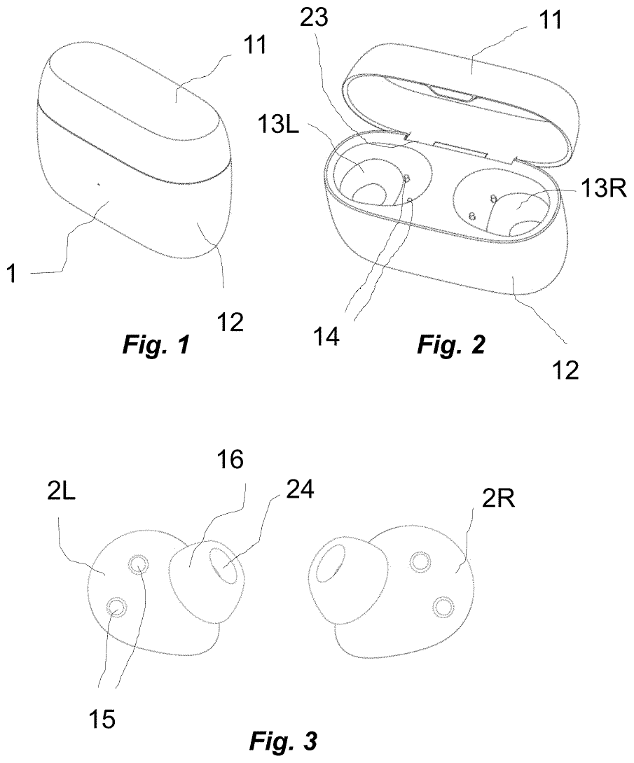

FIG. 1 is a perspective view of a closed charging case 1 according to a first embodiment of the invention. The charging case 3 comprises a bottom part 12 and a top part 11. The charging case 1 has a length of about 65 mm, a width of about 25 mm and a height of about 37 mm.

FIG. 2 shows the charging case 3 in an open state. The bottom part 12 has a left cavity 13L for receiving a left earbud 2L (see FIG. 3) and a right cavity 13R for receiving a right earbud 2R (see FIG. 3). When the top part 11 is moved to the open position by rotating around a hinge 23, the cavities 13L, 13R are exposed, so that the earbuds 2L, 2R can be arranged in or removed from the cavities 13L, 13R. Each cavity has two charging contacts 14.

FIGS. 3 is bottom views of the left earbud 2L and the right earbud 2R. They each comprise two earbud charging pads 15 and a soft eargel 16 for insertion into the ear canal of the user. A sound opening 24 leads to a speaker inside the earbud 2R, 2L. No further explanation of how the headset works will be given here, as it is not essential for understanding the invention.

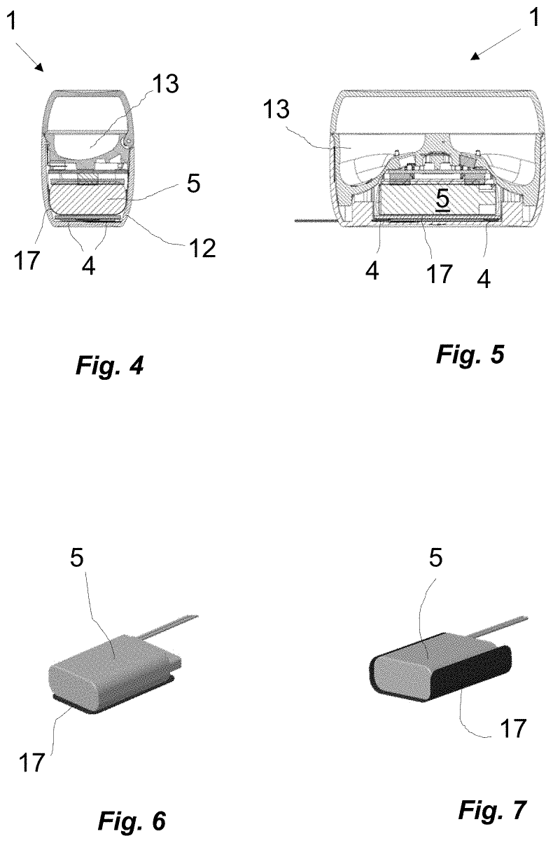

FIG. 4 is a cross-sectional view through the charging case 1. A rechargeable battery 5 is arranged in the bottom part 12. A magnetic shield sheet 17 is arranged to cover the lower side and two longitudinal vertical sides of the battery 5. A charger receiving coil 4 is arranged between the battery 5 and the bottom of the charging case 1. The outer dimension of the charging coil 4 is about 19 mm, and the inner dimension is about 17 mm. The battery 5 is about 23 mm wide, and about 10 mm high.

FIG. 5 is a longitudinal section through the charging case 4. The outer dimension of the charging coil 4 is about 36 mm and the inner dimension is about 32 mm. The battery 5 is about 32 mm long.

FIG. 6 is a simplified perspective view of a battery 5 and a magnetic shield sheet 17 according to prior art, where only the lower side of the battery is covered by the sheet 17.

FIG. 7 is a simplified perspective view of a battery 5 and a magnetic shield sheet 17 according to the invention. It is clear, that also the two longitudinal vertical sides of the battery 5 is covered by the magnetic shield sheet 17.

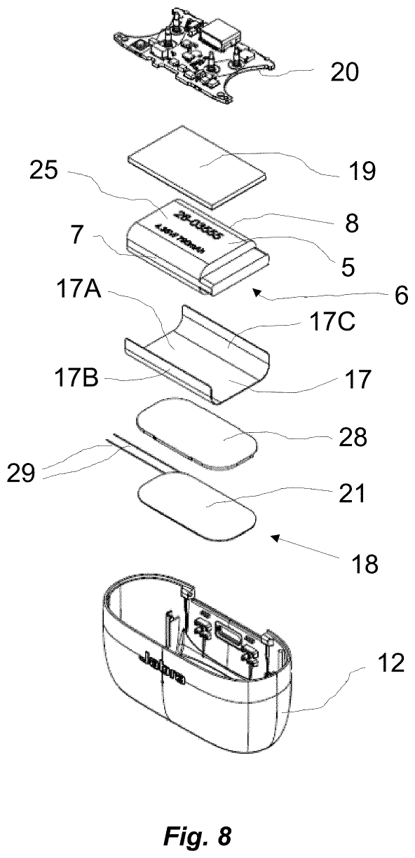

FIG. 8 is an exploded view of the major components of the charging case 1 according to a second embodiment of the invention. From the bottom of the bottom part 12 is arranged in the following order: a charging coil assembly 18, a sheet of filler material 28, a magnetic shield sheet 17, a battery 5, a heat insulating foam sheet 19 and a pcb (printed circuit board) 20. The charging coil assembly 18 comprises a carrier sheet 21 and a charger receiving coil 4 on the underside, which is not visible in FIG. 8. Connecting wires 29 for connecting the coil 4 to the charging electronics can be seen to the right. According to this embodiment, the battery 5 has a first flat bottom side 6, a flat top fourth side 25 and second and third longitudinal sides 7, 8 connecting the first and fourth sides 6, 25. The second and third longitudinal sides have rounded sections close to the first and fourth sides 6, 25. The magnetic shield sheet 17 has three sections 17A, 17B and 17C. A first section 17A covers the first battery side 6, a second section 17B covers the second battery side 7 and a third section 17C covers the third battery side 8.

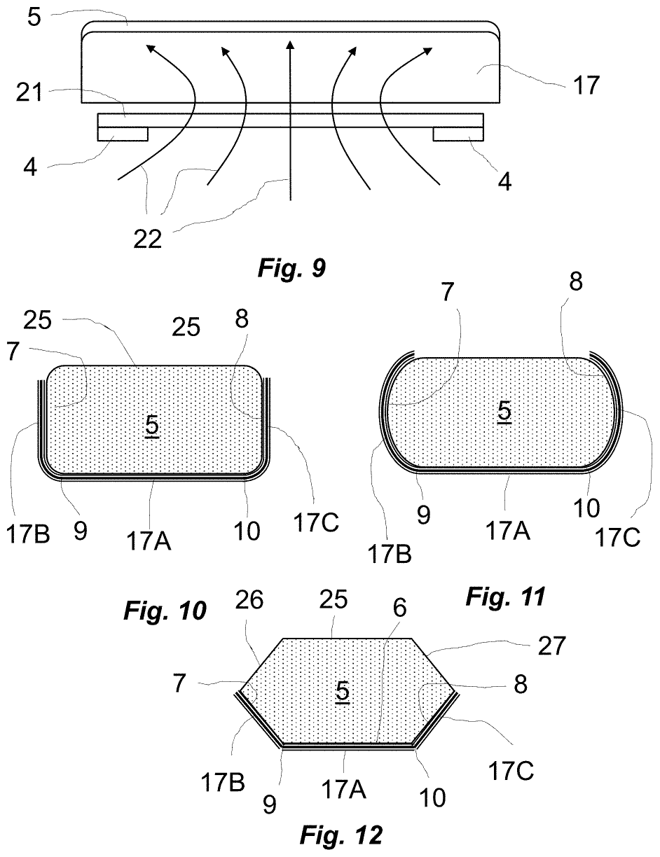

FIG. 9 is a schematic longitudinal view of parts of the invention with arrows indicating magnetic field lines 22 during charging. The battery 5 is normally packaged in an aluminium laminated film. If there was no magnetic shielding, the alternating magnetic field would induce eddy currents in the aluminium, which would add to the heating up of the battery 5. As the battery 5 is already being heated up due to the charging process causing chemical processes in the battery and also due to the high temperature of the PCB 20 lying on top of the battery 5, it may be necessary to lower the charging current, which causes a longer charging time. According to this invention, not only the side of the battery 5 facing the charger receiving coil 4 is covered by a magnetic shield sheet 17, but also the two longitudinal sides lying next to the bottom side is covered. This has surprisingly shown to reduce the heating of the battery 5 during charging further.

The magnetic shield sheet 17 can comprise different materials such as ferrite or amorphous cobalt alloys. The sheet 17 is preferable a bendable sheet which can be bend around the edges 9, 10 of the battery 5 during assembly and attached to the battery be means of an adhesive.

In a preferred embodiment, the magnetic shielding sheet 17 is a laminate comprising a cover tape, a magnetic metal sheet and a double adhesive layer with a total thickness of about 0.125 mm. Saturation magnetic flux Density is about 1.56 T, density is about 7.18 g/cm³, and resistivity is about 130 μΩCm. A magnetic shielding sheet as described in EP2797092 B1 can be used.

FIG. 10 is a schematic cross-sectional view through a simplified third embodiment of the invention. The second and third sides 7, 9 of the battery 5 are planar except for upper and lower regions where they are connected to the first and fourth sides 6, 25. The edge 9 is the border between the first side 6 and the second side 7. The edge 10 is the border between the first side 6 and the third side 8.

FIG. 11 is a schematic cross-sectional view through a simplified fourth embodiment of the invention. Here, the second and third sides 7, 8 of the battery 5 are curved.

FIG. 12 is a schematic cross-sectional view through a simplified fifth embodiment of the invention. This battery 5 has a hexagonal cross-section. The second and third sides 7, 8 are flat and extend obliquely outward from the first side 6.

### REFERENCE SIGNS

1 Charging case

2 Headset

3 Housing

4 Charging receiver coil

5 Rechargeable battery

6 First battery side

7 Second battery side

8 Third battery side

9 First edge

10 Second edge

11 Top part

12 Bottom part

13 Recess

14 Charging pins

15 Charging pads

16 Eargel

17 Magnetic shield sheet

18 Charging receiver coil assembly

19 Heat insulating foam sheet

20 PCB

21 Carrier sheet

22 Magnetic field lines

23 Hinge

24 Sound opening

25 Fourth side of battery

26 Fifth side of battery

27 Sixth side of battery

28 Filler material

29 Connecting wires

1. A wireless charging case for a headset, which case comprises
a housing,
a charging receiver coil,
a rechargeable battery comprising
a first battery side extending between a first edge and a second opposite edge and facing the charging receiver coil,
a second battery side lying extending from the first edge and a third battery side extending from the second edge, wherein
magnetic shield sheet is arranged between the charging receiver coil and the first battery side,
wherein parts of the second battery side and third battery side are covered by magnetic shield sheet.

2. A wireless charging cradle according to claim 1, wherein a unitary magnetic shield sheet is wrapped around the first, second and third battery sides.

3. A wireless charging cradle according to claim 1, wherein the battery is essentially box shaped, wherein the second and third battery sides are essential parallel and essential orthogonal to the first battery side.

4. A wireless charging cradle according to claim 1, wherein the second and third battery sides are essentially fully covered by magnetic shield material.

5. A wireless charging cradle according to claim 1, wherein the area of first battery side is between 5 cm² and 10 cm², and the area of the second and third battery sides is between 2.5 cm² and 5 cm².

6. A wireless charging cradle according to claim 1, wherein the magnetic shield sheet comprises ferrite.

7. A wireless charging cradle according to claim 1, wherein the magnetic shield sheet comprises an amorphous cobalt alloy.

8. A wireless charging cradle according to claim 1, wherein the charging receiver coil is arranged at a bottom face of the housing.

9. A wireless charging cradle according to claim 1, wherein the magnetic shield sheet is flexible.

10. A wireless charging cradle according to claim 1, wherein the magnetic shield sheet adhered to the surface of the.
